(19) United States
(12) Patent Application Publication
(10) Pub. No.: US 2008/0063868 A1
(43) Pub. Date: Mar. 13, 2008

(54) FUNCTIONALIZED SILICA NANOPARTICLES HAVING POLYETHYLENE GLYCOL LINKAGE AND PRODUCTION METHOD THEREOF

(75) Inventors: Doo Soo CHUNG, Seoul (KR); Hye Sun YOO, Seoul (KR)

Correspondence Address: CANTOR COLBURN, LLP, 20 Church Street, 22nd Floor, Hartford, CT, 06103, US

(73) Assignees: SAMSUNG ELECTRONICS CO., LTD., Suwon-si (KR); SEOUL NATIONAL UNIVERSITY INDUSTRY FOUNDATION, Seoul (KR)

(21) Appl. No.: 11/851,733

(22) Filed: Sep. 7, 2007

(30) Foreign Application Priority Data
Sep. 9, 2006 (KR) 10-2006-0087118

(51) Int. Cl. B32B 5/16; C08K 9/00

(52) U.S. Cl. 428/402; 523/216

(57) ABSTRACT

Disclosed are herein functionalized silica nanoparticles having polyethylene glycol linkages and a production method thereof. More specifically, example embodiments relate to functionalized silica nanoparticles that avoid of aggregation nanoparticles via introduction of PEG linkages onto the nanoparticles and have high reactivity via introduction of PEG which links a ligand to a target cell, and a production method thereof.

### PRIORITY STATEMENT

This application claims priority under 35 U.S.C. § 119(a) to Korean Patent Application No. 2006-87118 filed on Sep. 9, 2006, which is herein incorporated by reference.

### BACKGROUND

1. Field

Example embodiments relate to functionalized silica nanoparticles having polyethylene glycol linkages and a production method thereof. More specifically, example embodiments relate to functionalized silica nanoparticles that prevent aggregation of nanoparticles via introduction of PEG linkage onto the nanoparticles and have high reactivity via introduction of PEG linking a ligand with a target cell, and a production method thereof.

2. Description of the Related Art

In recent years, nanoparticle-based techniques have suggested great potential in the field of bioassay and biomedicine including high-quality high-quantity screening, chip-based techniques, multi-purpose detection systems, diagnostic screening, and in vitro and in vivo diagnostics for complete biosystems such as tissues, blood and monocells. In microarray and microspotting technologies, spatial resolution of each reaction site on chips is considered considerably important, and advanced labeling and detection techniques are required to assay a smaller volume of sample and measure a limited area of a solid-phase sample. Use of fluorescent labels that promote specific activity and have minimized unspecific bondages is prerequisite for realization of optimum miniaturization in microarray (Raghavachari, N. et. al., Anal. Biochem. 2003, 312, 101-105).

Dye-immobilized silica nanoparticles among fluorescent labels have advantages of ease of surface-modification with various functional groups and applicability to biosystems, based on high quantum efficiency, optical stability, water-dispersibility and well-known chemical properties of silica, as compared to phosphorus and plasmon resonant particles which are up-converted by quantum dots, fluorescent dyes and high frequency. In addition, the size and fluorescence of the silica nanoparticles can be controlled according to specific demands of biological applications (Bagwe, R. P. et. al., Langmuir 2004, 20, 8336-8342). However, in nanoparticle-based bioassay, high sensitivity resulting from enhancement, selectivity and repetition of fluorescent signals is inhibited by the irreversible aggregation tendency of silica nanoparticles, and causes unspecific bonding. The reason for these phenomena is that the nanoparticles have a large hydrodynamic diameter (10 nm or higher) and a large surface area, as compared to dye molecules. In addition, excessively active functional groups which can be bound to surface-modified chemical and biological materials or interacted with the materials may induce false positive/negative signals. Accordingly, in designs of surface-modified nanoparticles for immobilizing biomaterials, controlled covalent bonding of the surface-modified nanoparticles with desired functional groups is essential. To accomplish successive and repeatable probe of biologically targeting sites via introduction of these fluorescent labels, silica nanoparticles must undergo no or minimal aggregation, and be well dispersed in an aqueous solution to avoid unspecific bonding of the nanoaprticles to biomaterials or substrates.

No research has been systematically conducted on surface functionality of nanoparticles for efficiency in the interaction between the nanoparticles and bio-analytes, and its effects (Xu, H. et. al., J. Biomed. Mater. Res., Part A 2003, 66, 870-879). In addition, to minimize aggregation of unspecific binding of the nanoparticles, there is a need for nanoparticle surface designs associated with optimal use of inactive and active surface functional groups.

### SUMMARY

After repeated attempts for introduction of various functional groups on silica nanoparticle surfaces, it was confirmed from cancer cell-targeted tests that aggregation and unspecific bindings of nanoparticles are minimized in the cases where PEG and folate groups are introduced on the nanoparticle surfaces. As a result, example embodiments have been finally completed.

Therefore, example embodiments provide functionalized silica nanoparticles having a structure in which polyethylene glycol and folate groups are introduced onto the surface of the nanoparticles, to minimize aggregation and unspecific bindings of the nanoparticles.

Example embodiments provide a method for producing the silica nanoparticles.

Example embodiments provide functionalized silica nanoparticles having a structure in which the amine is introduced onto the surface of silica nanoparticles and the amine is bound to polyethylene glycol (PEG).

The silica nanoparticles may be further bound to folate, the folate bound to PEG.

Example embodiments provide a method for producing functionalized silica nanoparticles comprising: i) preparing dye-silica nanoparticles by reverse microemulsion process; ii) subjecting the dye-silica nanoparticles to surface-treatment with amine; and iii) introducing PEG into the amine.

The method may further comprise, after step iii), linking folate to the silica nanoparticles.

### BRIEF DESCRIPTION OF THE DRAWINGS

Example embodiments will be more clearly understood from the following detailed description taken in conjunction with the accompanying drawings, in which:

FIG. 1 is a schematic diagram illustrating a process for surface-modifying dye-immobilized silica nanoparticles using reverse microemulsion synthesis according to example embodiments of nanoparticle preparation;

FIG. 2 is a schematic diagram illustrating a preparation process of nanoparticles using reverse microemulsion synthesis in more detailed;

FIG. 3a, 3b, 3c and 3d are images showing the cases where 30 ppm of nanoparticles are applied to KB cells;

FIG. 4a, 4b, 4c and 4d are images showing the cases where 30 ppm of nanoparticles are applied to MDA cells;

FIG. 5a, 5b, 5c, 5d, 5e and 5f are images showing the cases where 30 ppm of the nanoparticles having phosphonate linkages introduced through THPMP are applied to KB cells;

FIG. 6a, 6b, 6c, 6d, 6e and 6f are images showing the cases where 30 ppm of the nanoparticles having phosphonate linkages introduced through THPMP are applied to MDA cells.

### DESCRIPTION OF THE PREFERRED EMBODIMENTS

Example embodiments will now be described in greater detail.

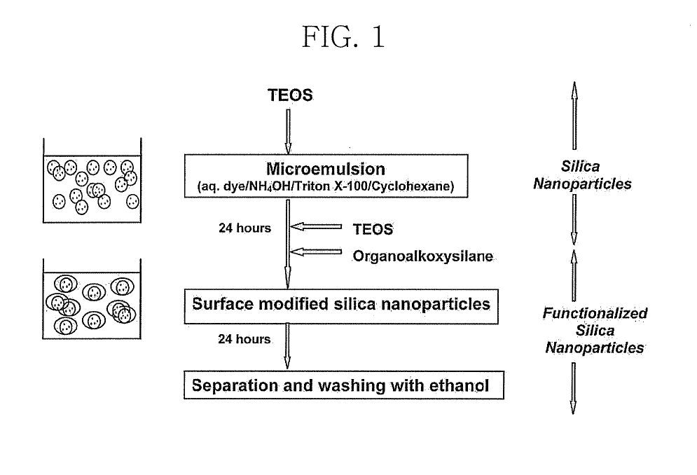

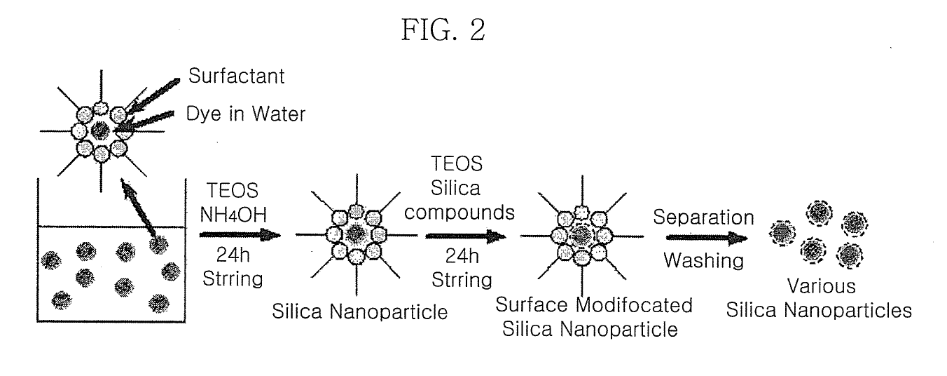

FIG. 1 is schematic diagram illustrating a conventional process of surface-modification of dye-immobilized silica nanoparticles using reverse microemulsion synthesis according to example embodiments of nanoparticle preparation (Langmuir 2006, 22, 4358). Specifically, the surface-modification comprises the steps of: a) preparing silica nanoparticles; and b) imparting functionality to the silica nanoparticles via surface-modification. For better understanding, the process is schematized in FIG. 2. A more detailed description will be given below.

First, a dye was dissolved in an aqueous solution and a surfactant was added to the solution. As a result, the surfactant is arranged around dye molecules to form a fine space therebetween. The catalytic action of NH₄OH enables TEOS (tetraethyl orthosilicate) to surround the dye molecules. The reaction was maintained for 24 hours to obtain general dye-nanoparticles. Second, a silica compound having desired functionality groups was introduced into the dye-nanoparticles to impart functionality to the surface of the nanoparticles. The resulting nanoparticles were washed with ethanol and distilled water. As a result, various nanoparticles can be synthesized depending on the kind of the silica compound added.

Nanoparticles are required to avoid aggregation and be well bound to desired cells so that they function as a labeling material. This step aims to improve these requirements of the nanoparticles. Prior to surface-modification, the nanoparticles are weakly positive-charged. In a case where the nanoparticles are subjected to surface-modification with amine groups, the following process i.e. bonding of the nanopaticles with ligands may be unfavorable due to negative and positive charges on the surface thereof. In addition, since the nanoparticles whose surfaces are modified with amine only have a small cross-sectional surface area, they have a difficulty in avoiding aggregation. To prevent the aggregation problem, THPMP[(3-trihydroxysilyl)propylmethyl-phosphonate] may be added to the nanoparticles. However, in this case, binding of other groups with amine groups is still unfavorable because of steric hindrance. In a recent attempt to prevent the aggregation problem, use of carboxylethylsilanetriol sodium salts (CTES, 25 wt % in water) that allows octadecyltriethoxysilane and carboxyl groups to be bound to the nanoparticle surfaces was suggested. However, in cases to which various kinds of ligands are applied, more preferred is the use of amine-treated nanoparticles.

According to example embodiments, polyethylene glycol (PEG) is introduced into amine-treated nanoparticles for the purpose of preventing aggregation of nanoparticles. In addition, folate as a ligand is bound to such a nanoparticle. As this time, PEG may link the nanoparticle with folate. The structures of the nanoparticle will be shown below:

To prevent aggregation of nanoparticles and make bonding of the nanoparticle with the ligand favorable, more preferred is the structure on the right, where PEG links the nanoparticle with folate. The nanoparticle may have a structure on the left as a by-product, and this structure is encompassed in the scope of example embodiments.

The nanopaticle bound to amine groups are reacted with PEF-folate as depicted in the following reaction scheme.

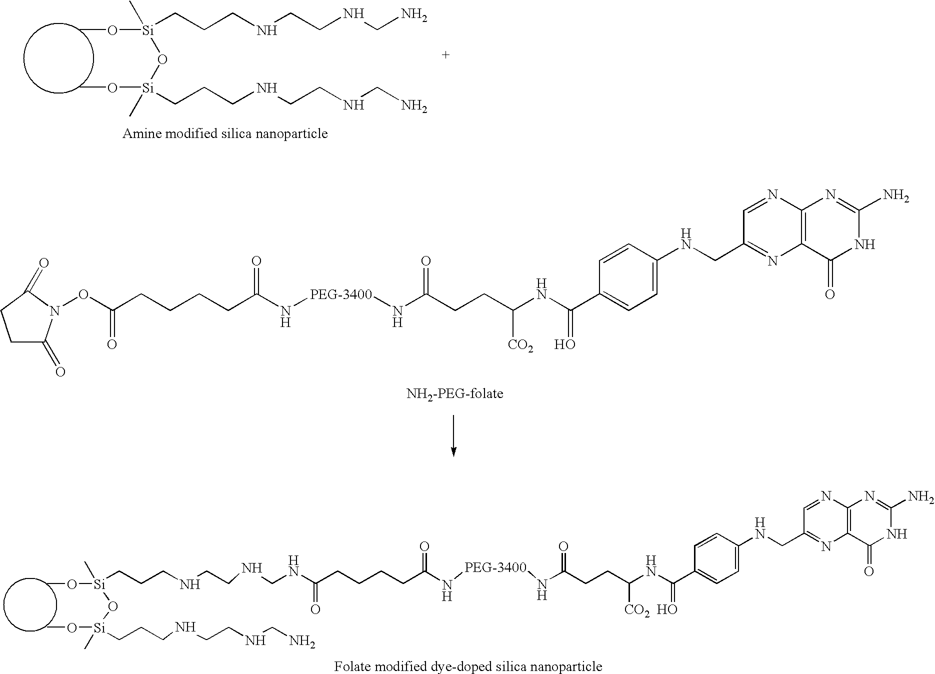

After the reaction, there are obtained nanoparticles having two functional groups (i.e. one of the functional groups functions to prevent aggregation and the other functions to link the nanoparticle to folate receptors).

Hereinafter, example embodiments will be explained in more detail with reference to the following examples. However, these examples are given for the purpose of illustration and are not to be construed as limiting the scope of the invention.

### EXAMPLES

### Example 1

### Synthesis of Nanoparticles

Nanoparticles were prepared by surface-modification via reverse microemulsion synthesis which is involved in microemulsification, followed by cohydrolysis of tetraethyl orthosilicate (TEOS) with organosilane reactants.

More specifically, 1.8939 g of triton® X 100 (Sigma-Aldrich, St. Louis, Mo.) as a surfactant, 7.5 mL of cyclohexane (Aldrich Chemical, Milwaukee, Wis.), 1.8 mL of 1-hexanol (Aldrich Chemical, Milwaukee, Wis.), 100 mL of tetraethyl orthosilicate (TEOS, Aldrich Chemical, Milwaukee, Wis.), 5.5×10⁻⁶ mol of Rubpy(tris(2,2-bipyridyl) dichlororuthenium (U) hexahydrate) (Aldrich, Milwaukee, Wis.), 480 mL of deionized water, and 60 mL of NH₄OH were reacted for 24 hours under light-shielding conditions with stirring, to yield general nanoparticles. This synthesis is well-known in the art.

### Example 2

### Bonding of Functional Groups to Nanoparticles

To prevent aggregation of the nanoparticles, various functional groups were bound to nanoparticle surfaces.

<2-1> Bonding of Phosphonate Group to Nanoparticles

50 mL of TEOS, 10 mL of APTS[(3-aminopropyl)triethoxysilane)] and 40 mL of THPMP[(3-trihydroxysilyl)propylmethyl-phosphonate] were introduced into the nanoparticles, followed by stirring (See: Dual-Luminophore-Doped Silica Nanoparticles for Multiplexed Signaling Lin Wang, Chaoyong Yang, and Weihong Tan, Nano Letters, 2005 5, 37-43).

<2-2> Bonding of Polyethylene Glycol (PEG) Groups to Nanoparticles

50 mL of TEOS, 10 mL of APTS[(3-aminopropyl)triethoxysilane)], and 40 mL of (MeO)₃Si-PEG(2-[methoxy(polyethyleneoxy)propyl]trimethoxysilane were introduced into the nanoparticles, followed by stirring for 24 hours. (See: Specific targeting, cell sorting, and bioimaging with smart magnetic silica core-shell nanomaterials, Yoon T J, Yu K N, Kim E, et al., SMALL 2, 209-215)

The amine-treated nanoparticles were reacted with folate-PEG-NHS in phosphate buffered saline (PBS) for 4 hours to prepare nanoparticles with two functional groups (one of the functional groups functions to prevent aggregation of the nanoparticles and the other functions to link the nanoparticles to folate receptors).

It was observed whether or not the nanoparticle aggregates were created in cancer cells, and the nanoparticles are well bound to the surface of an intended cell.

The cell lines herein used were KB cells and MDA-MB-231 cells, both of which were available from Korean cell line bank. The cells were cultured in a RPMI 1640 medium supplemented with 10% FBS and 5% Gentamicin. The cells were divided on a 6-well plate and incubated for 24 hours so that they were attached to cover glasses. The nanoparticles were introduced into the cells, followed by incubating for 3 hours.

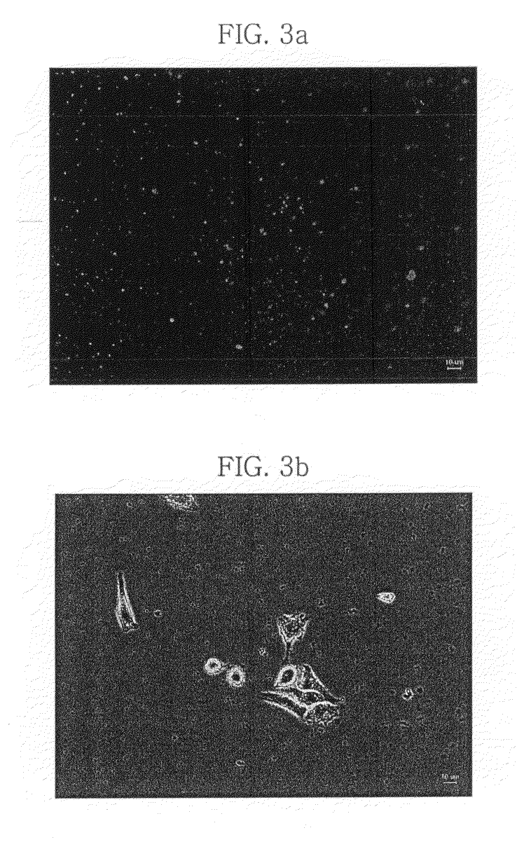

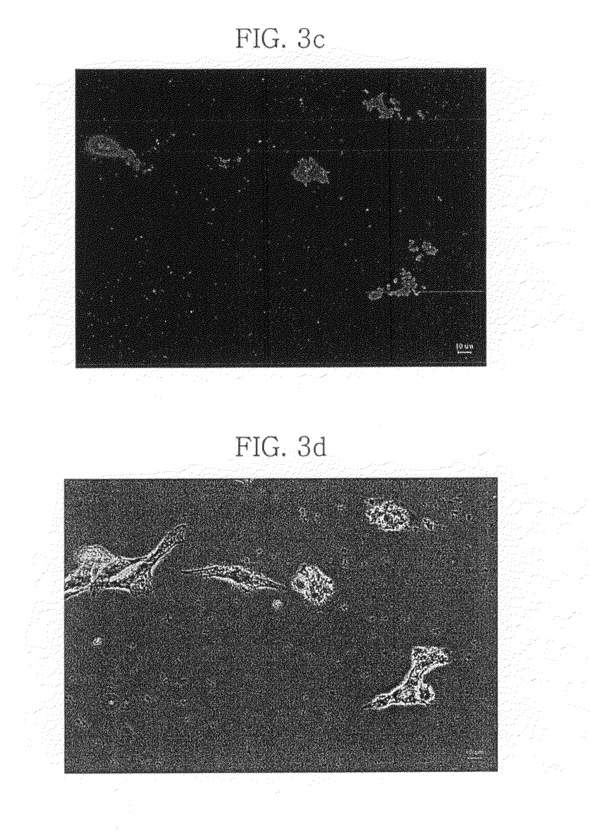

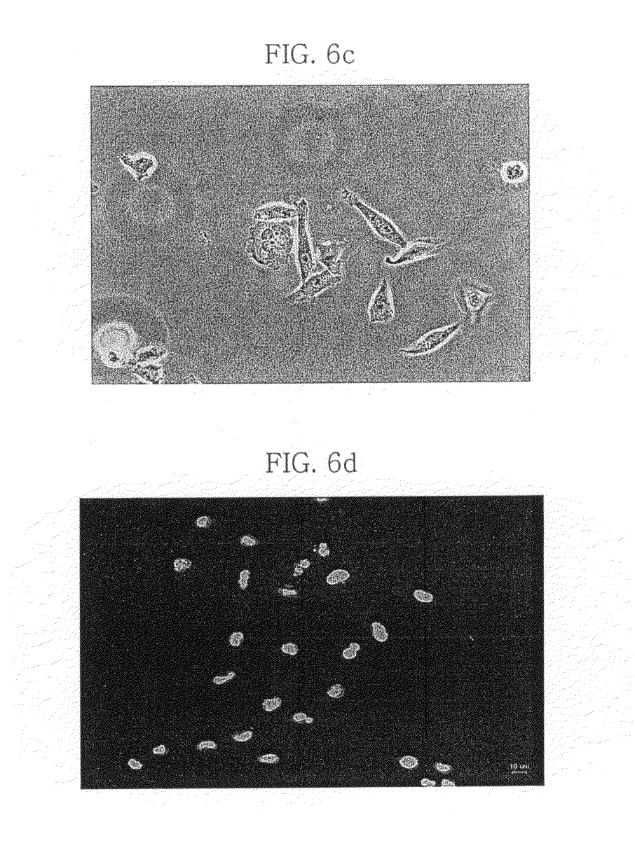

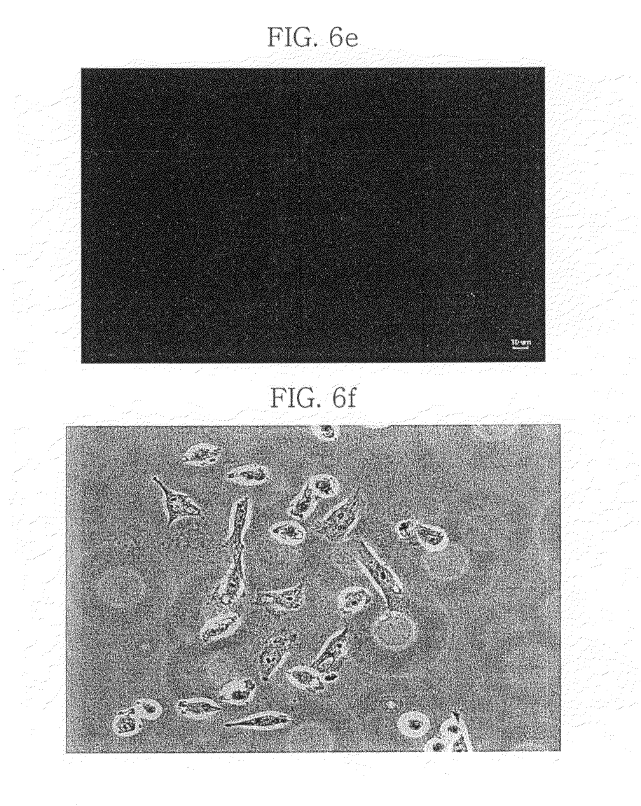

FIGS. 3 and 6 show results of the aforementioned experiment.

FIG. 3 are images showing the cases where 30 ppm of nanoparticles are applied to KB cells, more specifically, FIG. 3a is a fluorescent image of nanoparticles having no folate-PEG linkage as a control group, FIG. 3b is a phase-contrast image of nanoparticles having no folate-PEG linkage as a control group, FIG. 3c is a fluorescent image of nanoparticles having folate-PEG linkages as an experimental group, and FIG. 3d is a phase-contrast image of nanoparticles having folate-PEG linkages as an experimental group;

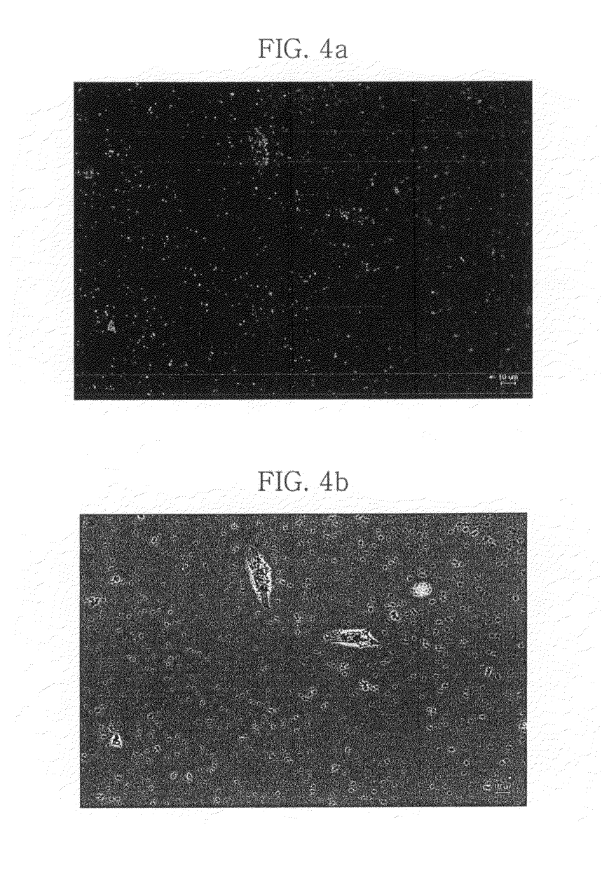

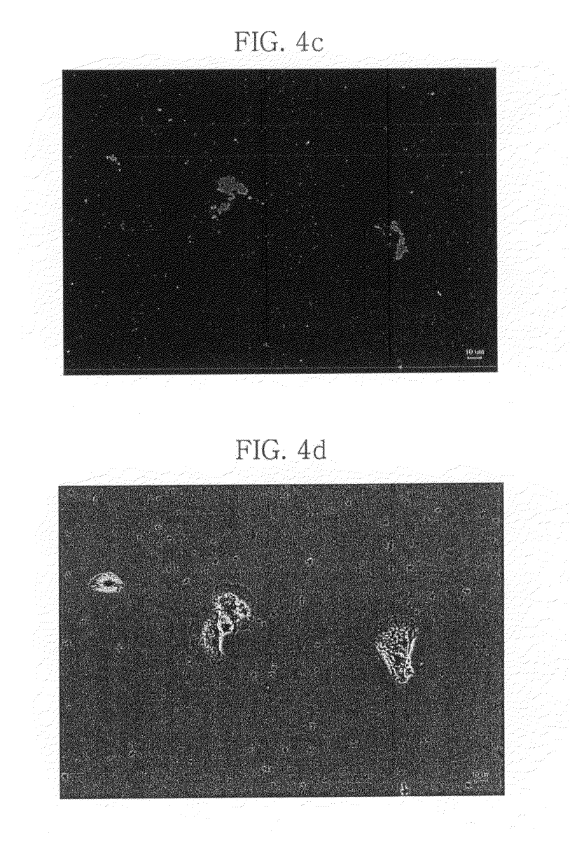

FIG. 4 are images showing the cases where 30 ppm of nanoparticles are applied to MDA cells, more specifically, FIG. 4a is a fluorescent image of nanoparticles having no folate-PEG linkage as a control group, FIG. 4b is a phase-contrast image of nanoparticles having no folate-PEG linkage as a control group, FIG. 4c is a fluorescent image of nanoparticles having folate-PEG linkages as an experimental group, and FIG. 4d is a phase-contrast image of nanoparticles having folate-PEG linkages as an experimental group;

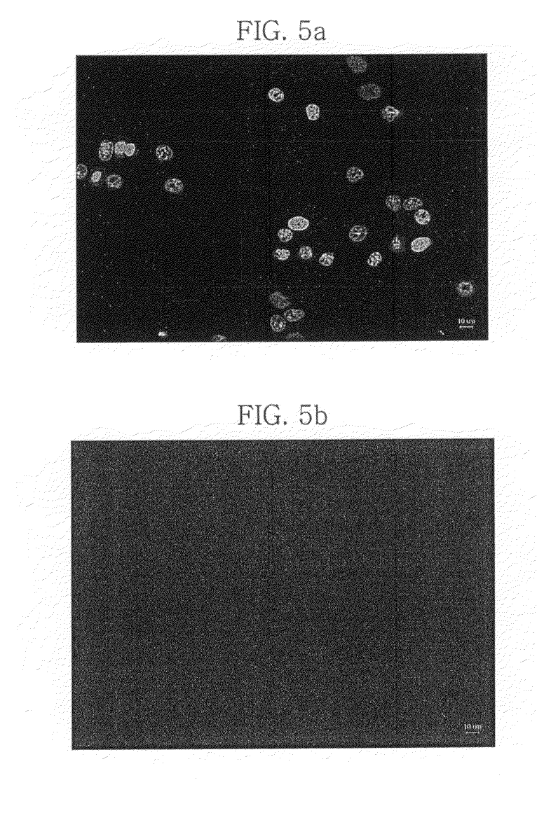

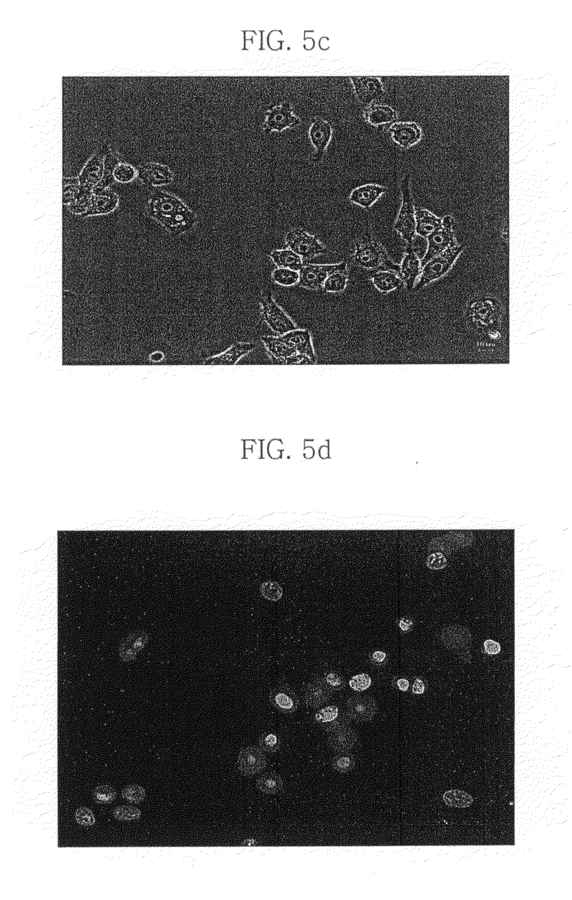

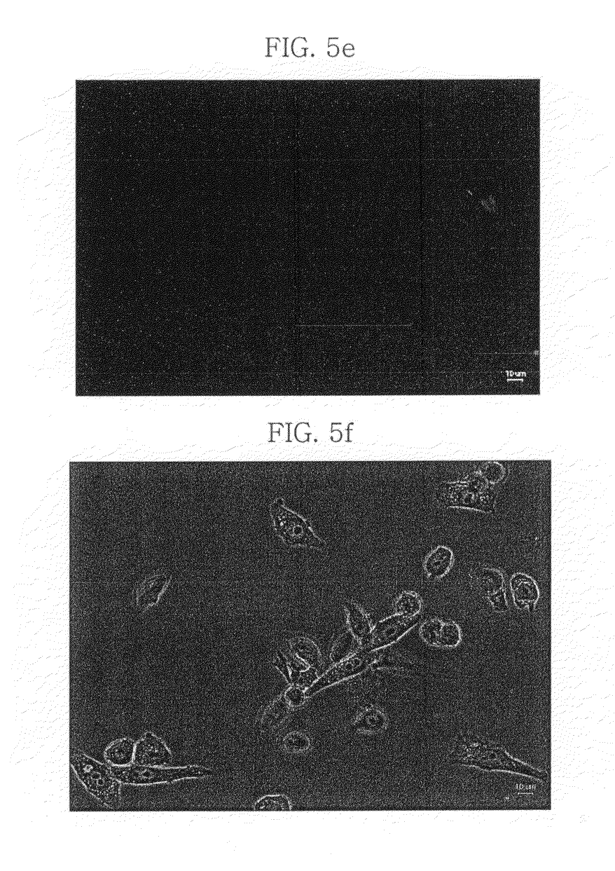

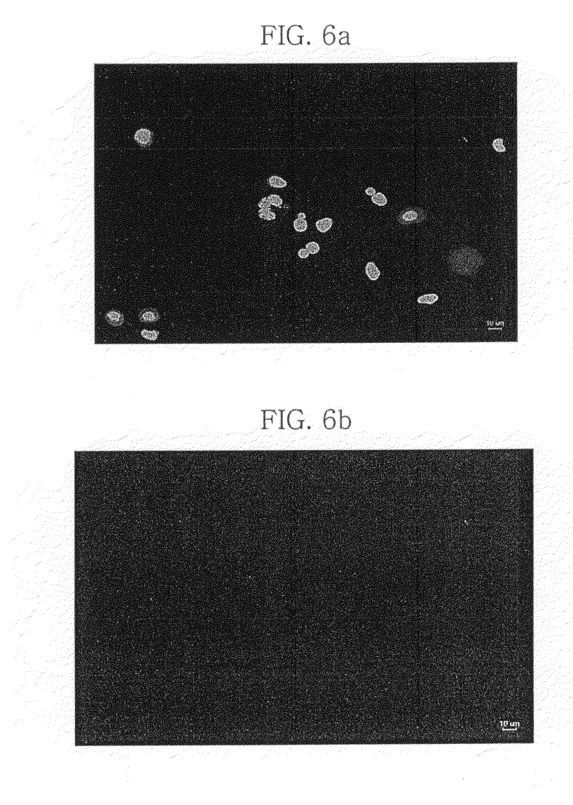

FIG. 5 are images showing the cases where 30 ppm of the nanoparticles having phosphonate linkages introduced through THPMP are applied to KB cells, more specifically, FIG. 5a is a fluorescent image confirming whether or not a fluorescent image of nanoparticles with phosphonate linkages and without folate-PEG linkage as a control group is observed in the cells, in the case where cell nuclei are dyed with DAPI dyeing, FIG. 5b is a fluorescent image of nanoparticles with phosphonate linkages and without folate-PEG linkage as a control group, FIG. 5c is a phase-contrast image of nanoparticles with phosphonate linkages and without folate-PEG linkage as a control group, FIG. 5d is a fluorescent image confirming whether or not a fluorescent image of nanoparticles having both phosphonate linkages and folate-PEG linkages as an experimental group is shown in the cells, in the case where cell nuclei are dyed with DAPI dyeing, FIG. 5e is a fluorescent image of nanoparticles having both phosphonate linkages and folate-PEG linkage as an experimental group, and FIG. 5f is a phase-contrast image of nanoparticles having both phosphonate linkages and folate-PEG linkage as an experimental group;

FIG. 6 are images showing the cases where 30 ppm of the nanoparticles having phosphonate linkages introduced through THPMP are applied to MDA cells, more specifically, FIG. 6a is a fluorescent image confirming whether or not a fluorescent image of nanoparticles with phosphonate linkages and without folate-PEG linkage as a control group is shown in the cells, in the case where cell nuclei are dyed with DAPI dyeing, FIG. 6b is a fluorescent image of nanoparticles with phosphonate linkages and without folate-PEG linkage as a control group, FIG. 6c is a phase-contrast image of nanoparticles with phosphonate linkages and without folate-PEG linkage as a control group, FIG. 6d is a fluorescent image confirming whether or not a fluorescent image of nanoparticles having both phosphonate linkages and folate-PEG linkages as an experimental group is shown in the cells, in the case where cell nuclei are dyed with DAPI dyeing, FIG. 6e is a fluorescent image of nanoparticles having both phosphonate linkages and folate-PEG linkages as an experimental group, and FIG. 6f is a phase-contrast image of nanoparticles having both phosphonate linkages and folate-PEG linkages as an experimental group.

It can be seen from FIG. 3 that the nanoparticles having no folate-PEG linkage shown in phase-contrast image as a control group (FIG. 3b) were not observed in a fluorescent image thereof (FIG. 3a), while the nanopaticles having folate-PEG linkages shown in a phase-contrast image as an experimental group (FIG. 3d) were observed in a fluorescent image thereof (FIG. 3c). Similarly, it can be seen from FIG. 4 that the nanoparticles having no folate-PEG linkage shown in phase-contrast image as a control group (FIG. 4b) were not observed in a fluorescent image (FIG. 4a), while nanoparticles having folate-PEG linkages shown in a phase-contrast image as an experimental group (FIG. 4d) were observed in a fluorescent image (FIG. 4c). Binding of PEG to nanoparticles for the purpose of preventing aggregation of nanoparticles disadvantageously causes slight background signals which are results from unspecific bindings of the nanoparticles on the surface of the cover glass. However, the background signals are considered insignificant, because they are very weak, as compared to cell signals.

These results demonstrate that the nanoparticles of example embodiments undergo no aggregation and are strongly bound to desired cell surfaces.

Meanwhile, it can be seen from FIGS. 5 and 6 that the nanoparticles having phosphonate introduced via THPMP cannot be favorably bound to desired cell surfaces, due to an obstacle to binding of other groups to the amine groups which are present on the surface of the nanoparticles. More specifically, as shown in FIG. 5, the structure of the nanoparticles shown in FIG. 5c is observed in a case where cell nuclei are dyed with DAPI dyeing (FIG. 5a), but is not observed in fluorescent image (FIG. 5b), because the nanoparticles have no ligand bound to cell surfaces. On the other hand, the structures shown in FIGS. 5d and 5f cannot be observed in a case where introduction of ligands into the nanoparticles is tried (FIG. 5e). These results indicate that folate-PEG groups cannot be bound to the nanoparticles because of any obstacle. The similar analytic results are obtained from those of FIG. 6.

As apparent from the foregoing, example embodiments provide functionalized silica nanoparticles that prevent aggregation of nanoparticles via surface-treatment and have high reactivity via introduction of PEG linking a ligand to a target cell.

Although example embodiments have been disclosed for illustrative purposes, those skilled in the art will appreciate that various modifications, additions and substitutions are possible, without departing from the scope and spirit of the invention as disclosed in the accompanying claims.

What is claimed is:

1. Functionalized silica nanoparticles having a structure in which the amine is introduced onto the surface of silica nanoparticles and the amine is bound to polyethylene glycol (PEG).

2. The functionalized silica nanoparticles according to claim 1, wherein the silica nanoparticles are further bound to folate.

3. The functionalized silica nanoparticles according to claim 2, wherein the folate is bound to PEG.

4. A method for producing functionalized silica nanoparticles comprising:
i) preparing dye-silica nanoparticles by reverse microemulsion process;
ii) subjecting the dye-silica nanoparticles to surface-treatment with amine; and
iii) introducing PEG into the amine.

5. The method according to claim 4, further comprising:
after step iii), linking folate to the silica nanoparticles.
